(19) United States
(12) Patent Application Publication
(10) Pub. No.: US 2009/0180175 A1
(43) Pub. Date: Jul. 16, 2009

(54) Optical scanning device having a freely programmable memory

(76) Inventor: Jürgen Tümpner, Münster (DE)

Correspondence Address: COLLARD & ROE, P.C., 1077 NORTHERN BOULEVARD, ROSLYN, NY, 11576, US

(21) Appl. No.: 11/990,789

(22) PCT Filed: Aug. 19, 2006
(86) PCT No.: PCT/EP2006/008191

§ 371 Date: Feb. 21, 2008

(30) Foreign Application Priority Data
Aug. 24, 2005 (DE) 102005039949.5

(51) Int. Cl. G02B 21/36

(52) U.S. Cl. 359/363

(57) ABSTRACT

The invention relates to an optical recording and/or reproducing unit which is especially suitable for scanning a preferably biological sample (1). The basic construction comprises an adjusting unit (8, 9, 10), a scanning unit (6), an optical unit (4, 5) and a control system (7). The control system (7) controls the adjusting unit (8, 9, 10) and optionally the optical unit (4, 5) and reads out the scanning unit (6). Data acquired in this manner are additionally processed in the control system (7). The control system (7) is equipped with at least one memory (11, 12) into which correction and/or characteristic values of individual units (4, 5; 6; 8, 9, 10) and/or other data are written. The invention is characterized in that the memory (11, 12) is configured as a user-programmable chip card with integrated processor.

The invention relates to an optical recording and/or reproduction unit, particularly for scanning a preferably biological sample, having an adjustment unit, a scanning unit, an optical unit, and having a control system that controls the adjustment unit and the optical unit, if applicable, and reads out the scanning unit and processes data obtained from it, whereby the control system is equipped with at least one memory, into which correction values and/or characteristic values of individual units and/or other data are written.

The adjustment unit generally has a table, i.e. sample table for accommodating the preferably biological sample. In addition, the adjustment unit generally has a setting drive for the optical unit, in order to change its focusing. Both the table, i.e. sample table and the setting drive for the optical unit are generally impacted by the control system. The optical unit can have one or more lenses, the selection of which might additionally be carried out by the control system. The scanning unit is usually a CCD chip, which is disposed in the image plane of the optical unit and serves to record sample images. The control system reads out the scanning unit and processes the optical data obtained in this manner.

In addition, the control system is equipped with a memory that is referred to as a correction memory within the framework of the prior art that forms the type, according to DE 40 20 527 A1. The input of the correction memory has an output signal of a lens setting transducer applied to it, and makes related correction signals available, as a function of input signals. In addition, the control system, i.e. a computer circuit ensures that offset correction signals are added to the output signals by position transducers.

Within the framework of DE 103 24 329 A1, an object carrier device for accommodating an object to be examined with a microscope or to be analyzed with a laboratory analysis system is described. This device has an object carrier that accommodates the object and a memory device. The memory device can be written to and/or read out by a read/write device, and has a chip card module.

The known prior art is restricted to correcting the optical unit, i.e. a lens situated there, in the final analysis. For this purpose, recourse is taken to a correction memory installed in fixed manner. This is no longer in keeping with today's demands regarding special flexibility of the memory modules. Furthermore, the method of functioning is restricted. This is where the invention wants to create a remedy, on the whole.

The invention is based on the technical problem of further developing an optical recording and/or reproduction unit of the type described initially, in such a manner that a correction of any desired units can be carried out, if necessary, and furthermore, there is a possibility of achieving quick adaptation of the overall system when individual units are exchanged.

In order to solve this technical problem, an optical recording and/or reproduction unit of the type stated is characterized in that the memory is configured as a freely programmable chip card having an integrated processor, if applicable.

According to the invention, this special memory, i.e. the freely programmable chip card, contains not only correction values, but also, in particular, characteristic values of the individual related units, and, if applicable, other data that will be discussed in greater detail below. In other words, for example in the case of a table or sample table as an integral part of the adjustment unit, values for its adjustment path, its size, its adjustment speed, possibly its spindle gradient in the case of a spindle drive that is implemented, etc., can be stored here. This means that the chip card that belongs to the adjustment unit, i.e. to the table or sample table, contains all of the values necessary for characterizing and controlling the table in question, in the case of the example. Furthermore, the chip card for the table or adjustment unit is equipped with correction values.

In order to obtain these correction values, a calibration is generally performed. For this purpose, the adjustment unit, i.e. the table can accommodate a reference mask that is equipped with markings at defined locations. When the table is now displaced, the markings might undergo an offset in their imaging, due to mechanical imprecisions, which offset can be detected. Alternatively or in addition, it is also possible to do without the reference mask. This presupposes that a contrast-rich sample is being recorded. Individual particularly contrast-rich regions or points can consequently be recorded on the basis of their location. This is because the pixel resolution is theoretically known in the case of the known optics and pixel size of the CCD chip that is used in most cases.

If the adjustment unit, i.e. the table is now displaced in multiple directions, a few—theoretically identical—images of the contrast-rich sample can be taken. Any deviations in the sample image can be attributed to mechanical imprecisions. In order to determine these mechanical imprecisions and consequently to find correction values, the sample images, in each instance, can be subjected to a correlation evaluation, as it is described, for example, in the book “Bildverarbeitung für Einsteiger” [Image processing for beginners], B. Naumann, Springerverlag, 2004, on page 167 ff. Of course, other comparison methods of image processing can also be used to determine differences between the individual sample images, and are covered. The overlapping regions of the samples are examined using the correlation evaluation, in the case of the example, to determine whether there are agreements or deviations. The correction values can then be derived from possible deviations, and statements concerning the travel characteristics of the table can be made.

One way or another, in an ideal case, a correction matrix is available for every X/Y value to which the table, i.e. the adjustment unit generally travels, at the end of the procedures described. The correction values, i.e. the correction matrix is now stored in the memory of the chip card that belongs to the table, i.e. the adjustment unit—along with the characteristic values described above.

Fundamentally, an adjustment unit can also be used that makes use of a robot arm or a comparable X/Y and possibly Z adjustment device. In this case, too, the characteristic values of the robot arm can be stored on the related chip card, for example its adjustment speed, its adjustment range, etc. Likewise, the chip card accommodates correction values that can be determined and stored in memory, in a manner similar to that described above.

Aside from the table or sample table, a setting drive for the optical unit, as a component of the adjustment unit, can also be subject to mechanical insufficiencies. These can be mastered in a manner similar to that described above. For example, a dot-shaped object lying in the focus must be imaged in sharp focus, in each instance. If the setting drive for the optical unit and thus a related focal plane are now moved, the related sample or reference sample can be moved accordingly, in defined manner, in the Z direction. This means that in the case of the example, the table is moved synchronously with the setting drive for the optical unit. Any deviations during the subsequent focusing now correspond to a mechanical error in the setting drive, which can be stored in memory as a correction value for the related Z value.

In addition to these correction values that are mainly due to mechanical insufficiencies, optical corrections can also be stored in the memory of the programmable chip card. Such corrections can balance out a spherical or chromatic aberration, for example. A spherical aberration is understood to be the phenomenon that parallel bundles of rays having a finite opening angle demonstrate longitudinal deviation. This means that the sample image generated during the course of transillumination of the sample, for example, i.e. the related parallel rays, intersect the optical axis between a lens or lens system of the optical unit and the focus at different locations. Such spherical aberration errors lead to the result that a planar sample image, for example, is recorded in pillow shape or barrel shape, under some circumstances. Such distortions again can be determined using the reference mask that has already been mentioned, and stored in the memory of the chip card as related correction values.

The optical errors to be balanced out also include a chromatic longitudinal aberration, which takes into consideration that blue rays, for example, have a shorter focal width than red ones. In this case, too, the distortion or deformation as the result of the chromatic aberration, in each instance, can be separately determined for every color, and stored in the memory of the chip card as a correction value, in each instance.

Additional corrections are necessary, for example, if the optical unit has additional filters that are optionally taken into consideration. Such filters also tend to distort the sample image or that of the reference mask, and therefore also require correction. In addition to such geometrical optical errors, those that result on the basis of the different color interpretation and generally fall into the category of “color errors” must also be taken into consideration.

For example, the scanning unit, i.e. the CCD chip provided at this location, tends to overemphasize certain spectral colors. The same can hold true for an output unit such as a screen or also a printer. This means that it is necessary to assure balancing out at this location. For this purpose, a reference spectrum can be recorded and reproduced, and can undergo a comparison with an original image. Any deviations between the original image and the recorded or reproduced reference image then flow into related color correction values, which can additionally be stored in the memory of the chip card.

The color errors last mentioned also include a shading correction. This shading correction takes into consideration a possibly non-uniform image illumination of the sample, which is generally transilluminated, by means of the white-light source or another source (underneath the sample). Deviations from this non-uniform image illumination are now balanced out by means of related shading correction values. Here again, calibration is necessary, in that a non-structured surface, for example, is transilluminated as a reference sample, and its (gray value) distribution is recorded and stored in memory. By comparing the reproduced image with the reference image, correction values for the shading correction can be determined by pixel, and stored in the memory of the chip card.

Finally, in addition to the mechanical errors, the geometrical optical errors, and color errors described, electrical and/or electronic errors must also be taken into consideration. These can occur, for example, because the voltage of the (white) light source for transilluminating the sample varies during recording or also otherwise. The intensity variations that result from this would also require correction. It is possible here to record the voltage of the (white) light source, for example, and to protocol it in the control system, in order to be able to make corrections subsequently.

In the end result, an optical recording and/or reproduction unit is made available, which is convincing with its comprehensive error correction of not only mechanical errors but also geometrical optical errors, as well as, in addition, color errors and electrical/electronic errors. All the errors can be determined and quantified separately, by means of prior calibration procedures, and can be stored in the memory of the programmable chip card, for the unit being examined, in each instance. The errors represented can be linked or also weighted by means of the processor that is present on the chip card. Furthermore, the processor manages a dialog with the control system, and allows updating of the error values and/or characteristic values, if necessary. Finally, the processor can protocol operating frequencies of individual units, and draw conclusions from this, in such a manner that a replacement due to aging, a maintenance procedure, etc. are indicated. Also, the processor can take wear phenomena that are time-related or due to the operating frequency into consideration in the error values, more or less prospectively.

Of course, the aforementioned calibration procedures can also be performed at the same time with the measurement, in that the sample to be examined undergoes recording and imaging at the same time with the reference mask, for example. Furthermore, of course, a prior or accompanying calibration in comparison with the subsequent measurements also lies within the scope of the invention.

At the same time, the chip card is supplied with the required characteristic values of the unit, in each instance, in order to inform the control system about the unit that is connected, in each instance, during the dialog with this system. This means that on the basis of the characteristic values of the chip card, the control system “knows” what adjustment unit, scanning unit, optical unit, etc., is being used at any particular time, and can additionally query the stored correction values and take them into consideration during the subsequent image recording and possibly reproduction process. In this connection, the freely programmable chip card allows implementation of an interchangeable memory. Of course, multiple chip cards can also be provided, specifically in such a manner that each unit is equipped with a separate chip card, for example. In this way, the optical recording and/or reproduction unit described can be composed of units structured in different ways, which can be interchanged, in each instance, essentially in modular manner. The same holds true for the freely programmable chip card, which is also structured to be interchangeable, and thus can be adapted to changed conditions, newly recorded calibration values, etc., under some circumstances.

Additional advantageous embodiments of the invention will be explained in the following. Thus, the errors described above can also be taken into consideration, supplementally or alternatively, in that a transfer function is determined for the unit, in each instance. This transfer function takes into consideration all the deviations of an original image of the sample—caused by the unit, in each instance—from the sample image actually recorded and reproduced. This sample image is known to represent a convolution of the aforementioned transfer function with the original image. If the transfer function is known, conclusions concerning the original image can be drawn from the sample image.

According to the invention, this transfer function can now be determined once (or also multiple times), experimentally and/or theoretically, and stored in the memory of the chip card. In this manner, the transfer function can be linked with scanning values that were obtained, if necessary, whereby here, development usually takes place in the sense that conclusions concerning the original image already mentioned are drawn from the sample image. Details of such development, i.e. of the procedure that stands behind it, are described, for example, in the book “Bildverarbeitung für Einsteiger” [Image processing for beginners] by B. Naumann, Springer Verlag, pages 53 ff.

The transfer function can be continuously adapted on the basis of the scanning values determined, and written into the chip card. This procedure corresponds to the continuous calibration already mentioned above. In this connection, correction values are determined parallel to the scanning values that are generated, and stored in the memory of the chip card. The same holds true for the transfer function.

It has proven itself if the chip card communicates bidirectionally with the control system—in wireless and/or hardwired manner. In this way, the control system can write new calibration values obtained during the measurement, for example, back to the chip card, supplementally to the old calibration values and/or error correction values. Vice versa, the chip card provides the required characteristic values of the related unit or the multiple units, and, at the same time, their error correction values for an initial measurement.

Furthermore, it is possible and is covered by the invention if the chip cards communicate with one another—and not necessarily by way of the control system. In this way, transfer position can be acknowledged, for example. If a so-called slide loader, in other words a feed and charging device for individual samples, is used in the case of the example, it is possible that the chip card of the said slide loader, on the one hand, and the chip card of the sample table, on the other hand, perform a data exchange with regard to transfer of the sample from the slide loader to the table. The positions of the slide loader, on the one hand, and the table or adjustment unit, on the other hand, during this transfer, in each instance, can be exchanged in this manner. —It should be emphasized that the communication of the chip cards with one another and of the chip cards with the control system can fundamentally take place using any networks. Transmission via the Internet, but also by way of the power network in the sense of known network-linked data transmission, is possible.

Generally, the chip card is a commercially available smart card that corresponds to the relevant ISO standards, for example the ISO 7816 standard. In this way, the costs can be kept low, and furthermore, there is the possibility of being able to read the chip card without problems, using a chip card reader that is also commercially available. At the same time, the chip card reader serves to accommodate and hold the chip card in it, in interchangeable manner.

In addition to the unit-specific data, the chip card can also carry operator-specific data and prevent unauthorized access. In this case, the chip card is only inserted into the related chip card reader when the operator wants to utilize the optical recording and/or reproduction unit. In this connection, the chip card first of all puts the control system into a state in which it is comprehensively informed about the equipment configuration, in each instance. This means that the chip card transmits the characteristic values of the adjustment unit, the scanning unit, the optical unit, the output unit, etc., to the control system, for example, in order to inform the system about the current configuration. At the same time, the error correction values that belong to the unit being used, in each instance, are handed over to the control system, in order to correct the recorded scanning values accordingly. In addition, querying of the chip card takes place as to whether an authorized operator is accessing the recording and/or reproduction unit being addressed. Of course, the function last mentioned can also be carried out without exchanging the error correction values and the characteristic values.

Furthermore, the chip card can be used not only to check the authorized operator, but also, user-specific settings can be stored in its memory, for example a preferred lens, specific microscope settings, etc.

In any case, the control system compares the operator-specific data and data stored in the memory of the chip card with an access key stored in the memory of the control system for agreement. If agreement exists, an operator can access the optical recording and/or reproduction unit. In this connection, the invention, can, of course, store biometric data, such as a fingerprint, the iris of the eye, etc., in the memory of the chip card of the operator, in each instance. Of course, biometric data obtained in this manner can be used not only for the user rights described, but also for other applications, for example the preferred individual settings of the user as mentioned above.

In any case, the chip card is disposed in the interior of a housing for the optical recording and/or reproduction unit, so that a compact structural unit is available, the individual units of which can be structured to be interchangeable. In this connection, the chip card essentially takes on the function of a server, on which all the data relating to the unit, in each instance, are stored.

Furthermore, it has proven itself if the control system is connected with a communications network. In this manner, not only is there the possibility of remote control of some of the units. Rather, the data stored in the memory of the chip card can supplementally be remote-installed and/or remote-queried. This means that calibration of the adjustment unit, for example, does not have to be carried out at the setup location of the recording and/or reproduction unit, but instead can be carried out at a completely different location. The calibration values and related error correction values obtained in this manner are not transmitted to the control system of the optical recording and/or reproduction unit by way of the communications network (for example the Internet); the control system, in turn, writes the corresponding values to the chip card.

In this connection, the calibration values and related error correction values indicated above, in other words the correction values and/or characteristic values in general, can first be stored in a library that is independent of the chip card, in other words in an external memory. Only once the recording and/or reproduction unit in question is being operated, or the individual sub-units mentioned (scanning unit, optical unit, etc.) are being used are the values in question (correction values and/or characteristic values) transferred to the freely programmable chip card with the processor from the memory or the library. This process can be controlled by the processor on the chip card. The Internet or, under some circumstances, a company's own Intranet, are recommended as a communications network, as an example and without restriction.

In total, in this way there is the possibility of remote-controlling the said optical recording and/or reproduction unit from practically any location. In this connection, the remote control system is comprehensively informed about the characteristics and/or errors of the individual optical, mechanical, and electronic units, by the chip card. The data exchange can take place in encrypted manner, if desired. Furthermore, the unit, in each instance, can send an acknowledgement signal as soon as the command of the remote control system has been carried out.

Finally, the chip card can also have identification data in addition to the unit-specific and possibly operator-specific data. These identification data of the chip card are exchanged with the related unit and/or the control system, in each instance. In this way, there is the possibility of guaranteeing a clear assignment of the chip card and the related unit or related units. In this way, it is assured that the chip card, in each instance, can be inserted only into a related recording and/or reproduction unit, because in this regard, a “key/lock” principle is being implemented. This is particularly important if multiple operators and/or multiple recording and/or reproduction units are supposed to be operated locally at one location. Furthermore, the identification data might clearly point out the authorized user, so that in this case, too, the “key/lock” principle is being utilized.

In the following, the invention will be explained in greater detail using a drawing that shows an embodiment merely as an example; this shows:

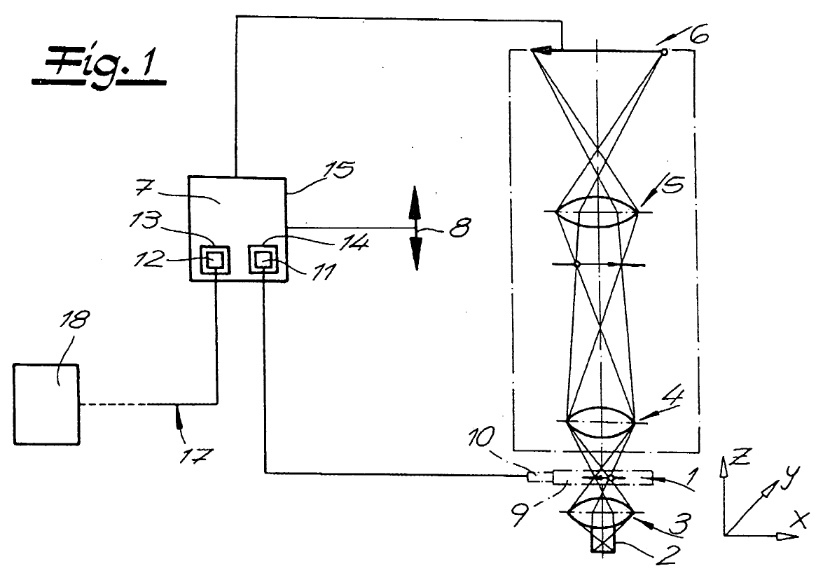

FIG. 1 an optical recording and/or reproduction unit according to the invention, schematically,

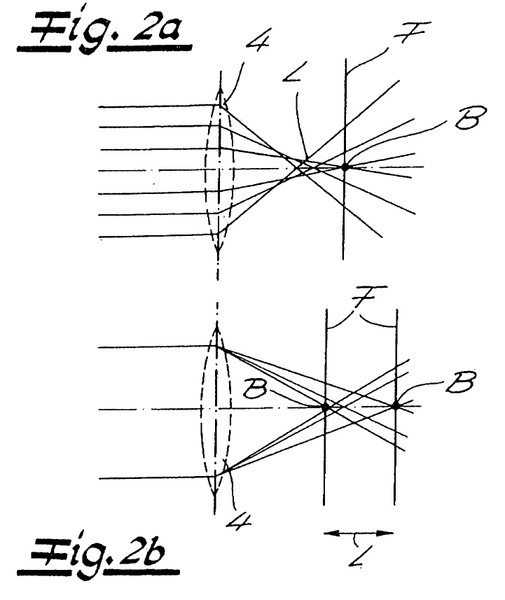

FIG. 2 an error correction in the case of a spherical aberration (FIG. 2a) and a chromatic aberration (FIG. 2b), and

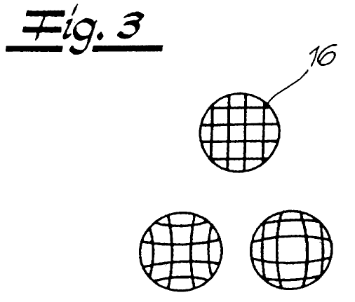

FIG. 3 related images of a reference mask that are distorted due to aberration.

In the figures, an optical recording and/or reproduction unit is shown, which is advantageously but not exclusively suitable for scanning a preferably biological sample 1. The sample 1 is accommodated by an object carrier and covered by a cover glass, which is also not compulsory. The sample 1 is a biological tissue section that is transilluminated by a white-light source 2 including condenser lens 3. The rays that proceed from the white-light source 2 penetrate the sample 1 and are imaged by the lens 4 as well as an optional projection lens 5, whereby the sample image is formed on a scanning unit 6. The scanning unit 6 is a CCD chip that is read out by a control system 7. The projection lens 5 is not necessary if the lens 4 has a focusing effect.

One way or the other, the lens 4 and the projection lens 5 together form an optical unit 4, 5, which has a setting drive 8 that is merely indicated.

The setting drive 8 makes it possible to move the optical unit 4, 5 in the Z direction in the exemplary embodiment, in order to be able to perform focusing. The setting drive 8 is connected with the control system 7.

A table or sample table 9 that can be moved in the X and Y direction, in the exemplary embodiment, but without restriction, is also connected with the control system 7. For this purpose, the table 9 has one or multiple additional setting drives 10, which are spindle drives within the framework of the exemplary embodiment, but without restriction. The setting drives 8, 10 and the table 9 together form an adjustment unit 8, 9, 10 that is connected with the control system 7. The control system 7 consequently controls the adjustment unit 8, 9, 10 and the optical unit 4, 5, the latter specifically in such a manner that the lens 4 and the projection lens 5, if applicable, are accommodated in a common tube, which is an integral part of a lens turret. The desired optical unit 4, 5 can now be selected using the control system 7, in that the lens turret mentioned is adjusted accordingly.

The control system 7 is furthermore equipped with a memory 11, 12. In fact, two interchangeable and freely programmable chip cards 11, 12 with integrated processor are provided as the memory 11, 12, in each instance. The two chip cards 11, 12 are interchangeably accommodated and held in related chip card readers 13, 14. The chip card 11, 12, in each instance, is structured in commercially available manner, according to the ISO standard already described, and disposed in the interior of a housing 15, as an integral component. In the present case, the housing 15 encloses the control system 7, but it can also accommodate the entire optical recording and/or reproduction unit shown in its interior.

Within the framework of the exemplary embodiment, and without restriction, the chip card 11, 12, in each instance, communicates bidirectionally, in other words in two directions, with the control system 7. This is done in hardwired manner in the present case, but can also take place in wireless manner, if the chip card 11, 12, including the related chip card reader 13, 14 is disposed at a remote location, for example. According to the representation, the one chip card 11 contains unit-specific data, while operator-specific data are written onto the other chip card 12. The chip card 12 prevents unauthorized access in that an operator must first be authorized and identified with regard to the optical recording and/or reproduction unit, using this chip card 12.

In contrast, the chip card 11 is provided with unit-specific values, specifically both with characteristic values and with correction values of each related unit. This is understood to mean that the adjustment unit 8, 9, 10, for example, is flanked with unit-specific data that might indicate the adjustment range of the table 9, the setting path of the setting drives 8, 10, in each instance, the step size, etc. In the case of the optical unit 4, 5, data concerning the magnification, the shutter opening, etc. are possible as unit-specific characteristic values. With regard to the scanning unit 6, data about the pixel size, the number of pixels, etc. belong to the unit-specific characteristic values.

Unit-specific correction values furthermore join these unit-specific characteristic values. In the simplest case, these include, in the case of the scanning unit 6 as an example, a color correction table that assures color correction of the scanning values recorded using the scanning unit 6, and balances out non-uniform color recording by the scanning unit 6. Furthermore, data about the spherical and chromatic aberration can be provided for the optical unit 4, 5, for example, in accordance with the example according to FIG. 2. It is known that the spherical aberration is a measure of what longitudinal deviation L a parallel bundle of rays having a finite opening angle has as compared with a focal point B that lies in a focal plane F. This longitudinal deviation L can be stored in memory as a related error correction value for the lens, i.e. the lens 4 of the optical unit 4, 5, specifically, according to the invention, on the chip card 11. The same holds true for the color correction values of the scanning unit 6 described above.

In addition to the spherical aberration (FIG. 2a), color-related deviations of the focal point also play a role; these are summarized in the category of chromatic aberration. This is schematically shown in FIG. 2b and can fundamentally be attributed to the fact that blue rays tend to have a shorter focal width than red ones. Since the sample 1 is transilluminated using the white-light source 2, error values for the chromatic aberration of the optical unit 4, 5 must additionally be taken into consideration. In this case, too, a longitudinal deviation L is observed between a focal point B that belongs to the blue components and that for the red components. This means that the longitudinal deviation L expresses the distance from the focal plane F, in each instance (cf. FIG. 2b).

Both of the phenomena described above, that of spherical and chromatic aberration, lead to the fact that a reference mask 16 shown in FIG. 3, for example, undergoes the distortions also shown in FIG. 3, bottom, specifically a pillow-shaped distortion or a barrel-shaped distortion. In this connection, the distortion can, of course, be different, depending on the color of the transilluminated light, and must find appropriate consideration. In any case, the reference mask 16 undergoes a quantifiable distortion or deformation, which represents a measure of the error connected with the selected unit 4, 5; 6; 8, 9, 10, in each instance. If the reference mask 16 has a defined pattern of markings in the case of the example, the location of the marking on the scanning unit 6, as changed by the distortion or deformation, can be determined and flanked with an error correction value.

All the error correction values together form or can be transformed into a transfer function that defines the influence of the unit 4, 5; 6; 8, 9, 10, in each instance, on an original image of the sample 1. The scanning image of the sample 1 on the scanning unit 6 (sample image) now represents the convolution of the aforementioned transfer function with the original image, i.e. the original image function. In this connection, the transfer function, i.e. the errors of the unit 4, 5; 6; 8, 9, 10, in each instance, as shown in FIG. 3, can be determined (once) experimentally and/or theoretically, and stored in the memory of the chip card 11 in question. In this way, it is possible to link the transfer function, i.e. the unit-specific correction values with scanning values that were obtained, in the control system 7, if necessary. Furthermore, there is the option to continuously adapt the aforementioned transfer function on the basis of the scanning values determined, and write it into the chip card 11.

This means that the control system 7 undertakes a development of the scanning values, for example on the basis of the correction values, i.e. error correction values that were obtained experimentally (once), or on the basis of the related transfer function, and thus determines the original image of the sample 1, i.e. the related original image function. This can be repeated for different situations. In this way, an averaged original image can be determined. Now, conclusions can be drawn concerning errors in the transfer function, from deviations of the multiple measured original images as compared with this averaged original image, which function undergoes a corresponding correction in the control system 7, which correction is written back into the chip card 11. Alternatively or in addition, it is also possible to continuously record an image of the reference mark 16, together with the sample 1. This means that the scanning unit 6 records not only the image of the sample, in each instance, but also that of the reference mark 16. In this way, continuous error correction can be carried out. In any case, the chip card 11 communicates with the control system 7 bidirectionally, in order to guarantee the data exchange described above.

Furthermore, the possibility of connecting the control system 7 to a communications network 17 is shown in FIG. 1 with a dot-dash line. This can be the Internet or an Intranet. In this way, another control system 18 can impact the units 4, 5; 6; 8, 9, 10, in each instance—by way of the control system 7—and read them out, if applicable. Also, it is possible to enter into a bidirectional data exchange with the chip card 11, by way of the communications network 17. The control system 18 is the remote control system already described initially. The two control systems 7, 18 are able to protocol any movements of the units 4, 5; 6; 8, 9, 10.

The further option of equipping each unit 4, 5; 6; 8, 9, 10 with its own chip card 11 is not shown. This is connected with the advantage that the unit 4, 5; 6; 8, 9, 10, in each instance, clearly forms a unit with its related chip card 11. Such assignment problems are also eliminated if the chip card 11 exchanges identification data with the related unit 4, 5; 6; 8, 9, 10, in each instance, or the control system 7. In this way, a clear assignment of the chip card 11 with the related unit 4, 5; 6; 8, 9, 10 can also be guaranteed. In the simplest case, the identification data of the unit 4, 5; 6; 8, 9, 10, in each instance, reflect the related serial number that is stored in the memory of the chip card 11, in order to be able to assign the unit-specific characteristic values and correction values of the related unit 4, 5; 6; 8, 9, 10 without a doubt.

Finally, it should be emphasized that the two chip cards 11, 12 can, of course, be combined into one chip card 11, 12. This one chip card 11, 12 then carries both the unit-specific correction values and characteristic values and the operator-specific data. In this case, the single chip card 11, 12 then contains all the data and key functions that allow the operator error-free work on the recording and reproduction unit in question.

1. Optical recording and/or reproduction unit, particularly for scanning a preferably biological sample (1), having an adjustment unit (8, 9, 10), a scanning unit (6), an optical unit (4, 5), and having a control system (7) that controls the adjustment unit (8, 9, 10) and the optical unit (4, 5), if applicable, and reads out the scanning unit (6) and processes data obtained from it, whereby the control system (7) is equipped with at least one memory (11, 12), into which correction values and/or characteristic values of individual units (4, 5; 6; 8, 9, 10) and/or other data are written, wherein the memory (11, 12) is configured as a freely programmable chip card (11, 12) having an integrated processor, if applicable.

2. Recording and/or reproduction unit according to claim 1, wherein a transfer function of the unit (4, 5; 6; 8, 9, 10), in each instance, is determined once, experimentally and/or theoretically, and stored in the memory of the chip card (11, 12), in order to be linked with scanning values that are obtained, in the control system (7), if necessary.

3. Recording and/or reproduction unit according to claim 1, wherein the transfer function is continuously adapted on the basis of the scanning values that are obtained, and written into the chip card (11, 12).

4. Recording and/or reproduction unit according to claim 1, wherein the chip card (11, 12) communicates with the control system (7) bidirectionally.

5. Recording and/or reproduction unit according to claim 1, wherein the chip card (11, 12) is structured in commercially available manner, and is interchangeably accommodated and held in a chip card reader (13, 14).

6. Recording and/or reproduction unit according to claim 1, wherein the chip card (11, 12) carries unit-specific and possibly identification data.

7. Recording and/or reproduction unit according to claim 1, wherein the chip card (11, 12) is disposed in the interior of a housing (15) as an integral component.

8. Recording and/or reproduction unit according to claim 1, wherein the control system (7) is connected with a communications network (17) so that the data stored on the chip card (11, 12) can be remote-installed and/or remote-queried.

9. Recording and/or reproduction unit according to claim 1, wherein each unit (4, 5; 6; 8, 9, 10) is equipped with a separate chip card (11, 12).

10. Recording and/or reproduction unit according to claim 1, wherein the chip card (11, 12) exchanges identification data with the related unit (4, 5; 6; 8, 9, 10), in each instance, or the control system (7), in order to guarantee a clear assignment of chip card (11, 12) and unit(s) (4, 5; 6; 8, 9, 10).
